(19) United States
(12) Patent Application Publication
(10) Pub. No.: US 2015/0340057 A1
(43) Pub. Date: Nov. 26, 2015

(54) DISK DRIVE UNIT AND METHOD OF MANUFACTURING THE SAME

(71) Applicant: Samsung Electro-Mechanics Japan Advanced Technology Co., Ltd., Shizuoka (JP)

(72) Inventor: Ryusuke SUGIKI, Shizuoka (JP)

(21) Appl. No.: 14/666,627

(22) Filed: Mar. 24, 2015

(30) Foreign Application Priority Data
May 23, 2014 (JP) 2014-107505

(51) Int. Cl. G11B 19/20; G11B 5/48

(52) U.S. Cl. CPC G11B 19/2009; G11B 5/4813

(57) ABSTRACT

A method manufactures a disk drive unit having a stator part that includes a base and a shaft member extending in an axial direction, and a rotor part that is rotatably supported by the stator part and includes a sleeve accommodating at least a part of the shaft member, and a hub fixed to an outer peripheral surface of the sleeve and including a setting surface on which a recording disk is set. The method includes fixing the hub to the outer peripheral surface of the sleeve, cutting the setting surface by a cutting tool that moves in a direction perpendicular to a rotational axis of the rotor part while rotating the rotor part, in a state in which the hub is fixed to the outer peripheral surface of the sleeve, and accommodating the shaft member in the sleeve after the cutting.

### CROSS-REFERENCE TO RELATED APPLICATIONS

This application is based upon and claims the benefit of priority of Japanese Patent Application No. 2014-107505 filed on May 23, 2014, the entire contents of which are incorporated herein by reference.

### BACKGROUND OF THE INVENTION

1. Field of the Invention

The present invention relates to a disk drive unit and a method of manufacturing the same.

2. Description of the Related Art

A disk drive unit, such as an HDD (Hard Disk Drive), for example, may include a shaft, and a rotor part that includes a sleeve and a hub. The sleeve surrounds the shaft, and the hub is fixed to an outer peripheral surface of the sleeve. In the disk drive unit, a recording disk is set on the hub, and the recording disk rotates together with the rotor part. A disk drive unit having such a configuration is proposed in Japanese Laid-Open Patent Publication No. 2011-047439, for example. In the disk drive unit having the configuration described above, when the hub is fixed to the sleeve by interference-fitting, such as press-fitting, shrink-fitting, or the like, for example, a distortion may occur in the sleeve. This distortion of the sleeve may increase an axial runout of a disk setting surface of the hub. When the axial runout of the disk setting surface of the hub increases, an axial runout of the rotating recording disk increases, to thereby increase the possibility of generating a write error and/or a read error.

### SUMMARY OF THE INVENTION

Embodiments of the present invention may provide a disk drive unit and a method of manufacturing the same, which can reduce the axial runout of the rotating recording disk.

According to one aspect of the present invention, a method of manufacturing a disk drive unit having a stator part that includes a base and a shaft member extending in an axial direction, and a rotor part that is rotatably supported by the stator part and includes a sleeve accommodating at least a part of the shaft member, and a hub fixed to an outer peripheral surface of the sleeve and including a setting surface on which a recording disk is set, includes fixing the hub to the outer peripheral surface of the sleeve; cutting the setting surface by a cutting tool that moves in a direction perpendicular to a rotational axis of the rotor part while rotating the rotor part, in a state in which the hub is fixed to the outer peripheral surface of the sleeve; and accommodating the shaft member in the sleeve after the cutting.

According to another aspect of the present invention, a method of manufacturing a disk drive unit having a stator part that includes a base and a shaft member extending in an axial direction, and a rotor part that is rotatably supported by the stator part and includes a sleeve accommodating at least a part of the shaft member, and a hub fixed to an outer peripheral surface of the sleeve and including a setting surface on which a recording disk is set, includes fixing the hub to the outer peripheral surface of the sleeve; and cutting the setting surface by a cutting tool that moves in a direction perpendicular to a rotational axis of the rotor part while rotating the rotor part, in a state in which the hub is fixed to the outer peripheral surface of the sleeve.

According to still another aspect of the present invention, a method of manufacturing a disk drive unit having a stator part that includes a base and a shaft member extending in an axial direction, and a rotor part that is rotatably supported by the stator part and includes a sleeve accommodating at least a part of the shaft member, and a hub fixed to an outer peripheral surface of the sleeve and including a setting surface on which a recording disk is set, including forming a stepped part on the outer peripheral surface of the sleeve; forming an engaging part that is to engage the stepped part on an inner peripheral surface of the hub; fixing the hub to the outer peripheral surface of the sleeve by engaging the engaging part to the stepped part; and cutting the setting surface by a cutting tool that moves in a direction perpendicular to a rotational axis of the rotor part while rotating the rotor part, in a state in which the hub is fixed to the outer peripheral surface of the sleeve.

Other objects and further features of the present invention may be apparent from the following detailed description when read in conjunction with the accompanying drawings.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIGS. 1A, 1B, and 1C are diagrams schematically illustrating an example of a general configuration of a disk drive unit in a first embodiment;

FIG. 2 is a cross sectional view illustrating an example of a bearing mechanism of the disk drive unit in the first embodiment;

FIG. 3 is a diagram illustrating an example of radial dynamic pressure generating grooves in the first embodiment;

FIG. 4 is a diagram schematically illustrating a state in which a cutting tool forms a microgroove in a cutting apparatus;

FIG. 5 is a diagram, on an enlarged scale, illustrating an example of a first radial dynamic pressure generating groove in the first embodiment;

FIG. 6 is a diagram, on an enlarged scale, illustrating an example of a configuration of a ring-shaped recess of the disk drive unit in the first embodiment;

FIG. 7 is a diagram for explaining a method of manufacturing the disk drive unit in the first embodiment;

FIG. 8 is a cross sectional view illustrating an example of the bearing mechanism of the disk drive unit in a second embodiment; and

FIG. 9 is a cross sectional view illustrating an example of the bearing mechanism of the disk drive unit in a third embodiment.

### DESCRIPTION OF THE PREFERRED EMBODIMENTS

In each of the figures described hereunder, those elements and parts that are the same or substantially the same are designated by the same reference numerals, and a description thereof will not be repeated where appropriate. In addition, dimensions of the parts in each of the figures are enlarged or reduced, where appropriate, in order to facilitate understanding of the parts. Further, in each of the figures, illustration of some of the parts that may be considered unimportant in describing embodiments is omitted for the sake of convenience.

In the following description, a disk drive unit in one embodiment may be mounted with a recording disk that magnetically records data, for example, and may be used as an HDD or the like.

### First Embodiment

### Configuration of Disk Drive Unit

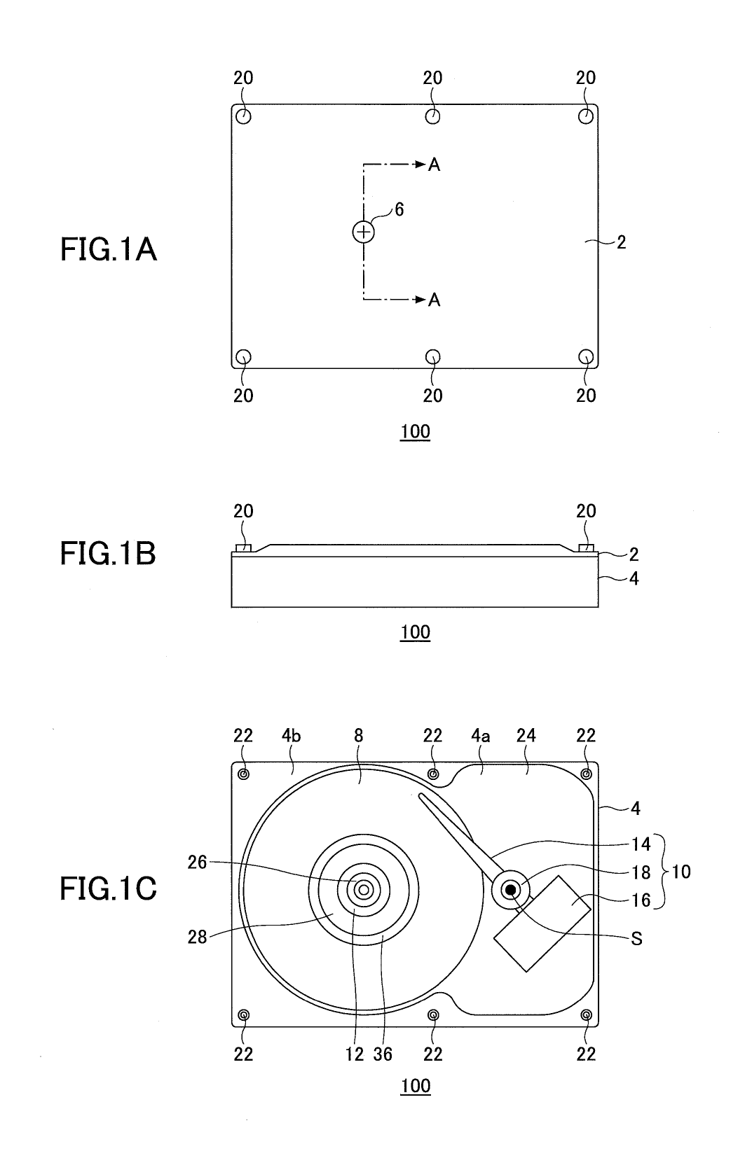

A description will be given of a disk drive unit 100 in a first embodiment, by referring to FIGS. 1A, 1B, and 1C. FIGS. 1A, 1B, and 1C are diagrams illustrating an example of a general configuration of the disk drive unit 100 in the first embodiment. FIG. 1A illustrates a plan view of the disk drive unit 100, FIG. 1B illustrates a side view of the disk drive unit 100, and FIG. 1C illustrates a plan view of the disk drive unit 100 in a state in which a top cover 2 thereof is removed.

The disk drive unit 100 includes the top cover 2, a base 4, a recording disk 8, a data read and/or write unit (hereinafter simply referred to as “data read/write unit”) 10, a cap 12, a shaft (or shaft member) 26, a hub 28, and a clamper 36.

In the following description, in a state in which the top cover 2 is mounted on the base 4, the side of the top cover 2 is referred to as an “upper side”, and the side of the base 4 is referred to as a “lower side”. In addition, a direction parallel to a rotational axis of the recording disk 8 is referred to as an “axial direction”, and an arbitrary direction passing through the rotational axis on a plane perpendicular to the rotational axis is referred to as a “radial direction”. Further, the side further away from the rotational axis along the radial direction is referred to as an “outer peripheral side”, and the side closer to the rotational axis along the radial direction is referred to as an “inner peripheral side”. These sides and directions do not limit an orientation of the disk drive unit 100 in use, and the disk drive unit 100 may be used in an arbitrary orientation.

(Top Cover)

The top cover 2 is formed by pressing an aluminum plate or a steel plate, for example. The top cover 2 may be subjected to a surface treatment such as plating or the like, for example, in order to prevent corrosion by a surface treated layer formed thereon by the surface treatment.

The top cover 2 is fixed on an upper surface of the base 4 by screws 20 located in a periphery of the top cover 2. The top cover 2 and the base 4 are fixed so as to seal the inside of the disk drive unit 100. A fixing screw 6 inserted through a center of the top cover 2 is screwed into a fixing screw hole of the shaft 26 that is fixed on the base 4.

(Base)

The base 4 includes a bottom surface 4a forming a bottom part of the disk drive unit 100, and an outer peripheral wall 4b that is formed along an outer periphery of the bottom surface 4a to surround a setting region in which the recording disk 8 is set. Screw holes 22 are provided in an upper surface of the outer peripheral wall 4b, and the screws 20 are screwed into the screw holes 22.

The top cover 2 is fixed on the upper surface of the outer peripheral wall 4b of the base 4 by the screws 20. A disk accommodating space 24 surrounded by the bottom surface 4a and the outer peripheral wall 4b of the base 4 and the top cover 2 is sealed and isolated from external environment, and is filled with clean air that is removed of dust or the like. Alternatively, the disk accommodating space 24 may be filled with a gas that includes a predetermined proportion of helium, for example. Accordingly, adhesion of foreign particles such as dust or the like onto the recording disk 8 can be suppressed, and the possibility of a malfunction caused by the foreign particles occurring in the disk drive unit 100 can be reduced.

The base 4 is formed by die casting using an aluminum alloy, or pressing a metal plate using stainless steel, aluminum, or the like, for example.

(Data Read/Write Unit)

The data read/write unit 10 includes a recording and reproducing head (not illustrated), a swing arm 14, a voice coil motor 16, and a pivot assembly 18. The recording and reproducing head is mounted on a tip end part of the swing arm 14, and is configured to record data on the recording disk 8, and to read data from the recording disk 8. The pivot assembly 18 pivotally supports the swing arm 14 to freely swing about a head rotational axis S as its center of swing. The voice coil motor 16 swings the swing arm 14 about the head rotational axis S as its center of swing, and moves the recording and reproducing head to a desired position on the surface of the recording disk 8. The voice coil motor 16 and the pivot assembly 18 may be formed using a known technique to control the position of the recording and reproducing head.

(Recording Disk)

The recording disk 8 may be formed by a 3.5-inch recording disk made of glass having a diameter of 95 mm, a thickness of 1.27 mm, and a center hole having diameter of 25 mm, for example. The recording disk 8 is mounted on an outer periphery of the hub 28.

<Configuration of Bearing Mechanism>

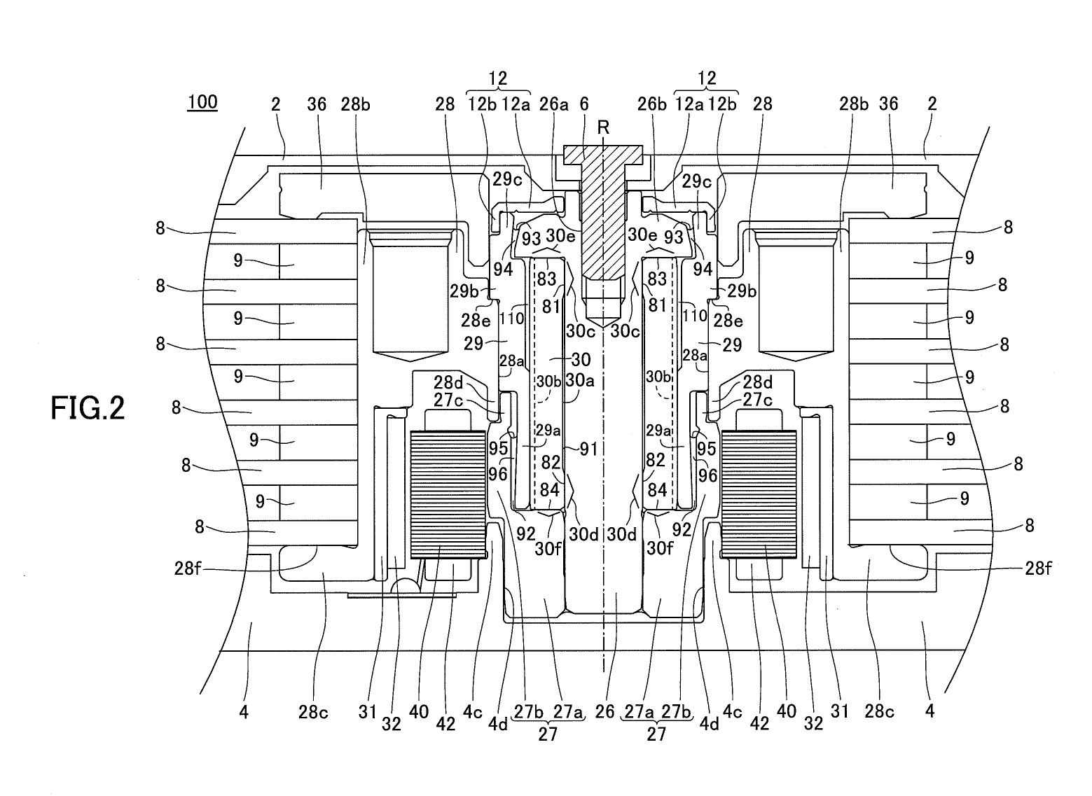

FIG. 2 is a cross sectional view illustrating a cross section along a line A-A in FIG. 1A. FIG. 2 illustrates an example of a bearing mechanism of the disk drive unit 100 in this embodiment.

The disk drive unit 100 includes a stationary body (hereinafter also referred to as a “stator part”) and a rotating body (hereinafter also referred to as a “rotor part”). The stator part includes the base 4, the shaft 26, a thrust cup 27, a stator core 40, and a coil 42. On the other hand, the rotor part includes the cap 12, the hub 28, a sleeve that includes an outer sleeve 29 and an inner sleeve 30, a yoke 31, a magnet 32, and the clamper 36. Hereinafter, a structure including the shaft 26 and the thrust cup 27 is also referred to as a “shaft body”, and a structure including the stator core 40, the coil 42, and the magnet 32 is also referred to as a “driving mechanism”.

In the disk drive unit 100, a lubricant 92 fills a gap between the outer sleeve 29 and the inner sleeve 30, and a gap between the shaft 26 and the thrust cup 27. The rotor part including the hub 28 mounted with the recording disk 8 is supported by the stator part including the shaft 26, to freely rotate about a rotational axis R as its center of rotation.

(Sleeve)

The disk drive unit 100 is provided with the sleeve that is formed by the inner sleeve 30 and the outer sleeve 29. The inner sleeve 30 accommodates at least a part of the shaft 26, and the outer sleeve 29 is fixed to an outer peripheral surface of the inner sleeve 30. The outer sleeve 29 and the inner sleeve 30 may be formed integrally by a single sleeve member.

The inner sleeve 30 may be made of a steel material, such as SUS430 which is a type of stainless steel, or the like. The inner sleeve 30 may be formed into an approximate cylindrical shape having a ring shape in a top view, by cutting the steel material, for example.

The shaft 26 is inserted into a shaft hole 30a of the inner sleeve 30, and the inner sleeve 30 accommodates the shaft 26 from a lower surface of a top flange 26b of the flange 26 to an upper surface of the thrust cup 27. The inner sleeve 30 is rotatably supported by the shaft 26 and the thrust cup 27 about the rotational axis R as its center of rotation. A holding gap 91 to hold the injected lubricant 92 is formed between the inner sleeve 30 and each of the shaft 26 and the thrust cup 27. In this embodiment, the lubricant 92 is continuously provided in the holding gap 91 from one gas-liquid interface to the other gas-liquid interface.

A D-cut surface is formed on the outer peripheral surface of the inner sleeve 30 along the axial direction thereof. The D-cut surface is a truncated flat surface, such that a cross section of the inner sleeve 30 along a direction perpendicular to the axial direction has a D-shape. A circulating passage 30b that circulates the lubricant 92 is formed between the D-cut surface of the inner sleeve 30 and an inner peripheral surface of the outer sleeve 29 that is fixed to the outer peripheral surface of the inner sleeve 30, by communicating the holding gap 91 on the side of the top flange 26b of the shaft 26 and the holding gap 91 on the side of the thrust cup 27. In the case in which the outer sleeve 29 and the inner sleeve 30 are integrally formed by the single sleeve member, a circulating passage that includes a hole extending in the axial direction may be provided in the sleeve member.

The outer sleeve 29 may be made of a steel material, such as SUS430, or the like. The outer sleeve 29 may be formed into an approximate cylindrical shape having a ring shape in the top view, by cutting the steel material, for example.

A lower end part 29a of the outer sleeve 29 makes contact with and is fixed to the outer peripheral surface of the inner sleeve 30 by interference-fitting, such as press-fitting, shrink-fitting, or the like, for example, and the outer sleeve 29 surrounds the inner sleeve 30. In addition, an upper end part 29c of the outer sleeve 29 surrounds the top flange 26b of the shaft 26. The cap 12 is fixed to an outer peripheral surface of the upper end part 29c by interference-fitting, such as press-fitting, shrink-fitting, or the like, for example.

A ring-shaped recess 110 is formed between the outer sleeve 29 and the inner sleeve 30 to surround the rotational axis R. The ring-shaped recess 110 is formed in a region that overlaps at least a part of a first radial dynamic pressure generating part 81 along the axial direction. The first radial dynamic pressure generating part 81 will be described later. A description on the configuration of the ring-shaped recess 110 will be given later in the specification.

The outer sleeve 29 includes a stepped part 29b. The stepped part 29b is formed by a radially extending part that projects in a ring-shape from the outer peripheral surface of the outer sleeve 29 along the radial direction, and a constricted part that is formed under the radially extending part. The hub 28 includes an engaging part 28e. The engaging part 28e is formed by a radially extending part and a constricted part that correspond to the stepped part 29b of the outer sleeve 29. The hub 28, which is fixed to the outer peripheral surface of the outer sleeve 29, is positioned with respect to the outer sleeve 29 along the axial direction, when the engaging part 28e engages the stepped part 29b of the outer sleeve 29.

Accordingly, the hub 28 and the outer sleeve 29 are positioned with a high accuracy due to the engaging part 28e that engages the stepped part 29b. Because the hub 28 and the outer sleeve 29 can be positioned with the high accuracy using a relatively simple configuration, an operation to assemble the hub 28 and the outer sleeve 29 can be simplified, and a productivity of the disk drive unit 100 can be improved.

(Hub)

The hub 28 may be made of a nonmagnetic steel material, such as aluminum, or the like, for example. The hub 28 may be formed into an approximate cup-shape having a ring shape in the top view, by subjecting the nonmagnetic steel material to cutting, pressing, or the like, for example.

The hub 28 includes a center hole 28a into which the outer sleeve 29 is inserted, a fitting part 28b that fits into the center hole of the recording disk 8, a setting part 28c on which the recording disk 8 is set, a cylindrical part 28d that covers a gap between the outer sleeve 29 and a surrounding part 27b of the thrust cup 27, and the engaging part 28e that engages the stepped part 29b of the outer sleeve 29.

The hub 28 is fixed to the outer peripheral surface of the outer sleeve 29 that is inserted into the center hole 28a, by interference-fitting, such as press-fitting, shrink-fitting, or the like, for example. Hence, the hub 28 is rotatably supported, together with the outer sleeve 29 and the inner sleeve 30, by the stator part that includes the shaft 26 and the thrust cup 27. An adhesive may be provided between a wall defining the center hole 28a of the hub 28 and the outer peripheral surface of the outer sleeve 29. In addition, such an adhesive may include a fluorescent material.

As described above, the engaging part 28e provided at the inner peripheral surface of the hub 28 engages the stepped part 29b of the outer sleeve 29. In addition, as described above, the hub 28 is positioned with respect to the outer sleeve 29 along the axial direction, when the engaging part 28e engages the stepped part 29b of the outer sleeve 29.

A setting surface 28f on which the recording disk 8 is set is cut to be perpendicular with respect to the rotational axis R, in a state in which the hub 28 is fixed to the outer sleeve 29. More particularly, the setting surface 28f is cut by a cutting tool, that moves in a direction perpendicular with respect to the rotational axis of the outer sleeve 29 and the inner sleeve 30, and cuts the hub 28 that is held by a jig of a cutting apparatus and rotated.

Accordingly, by cutting the hub 28 to form the setting surface 28f after the hub 28 is fixed to the outer sleeve 29, it is possible to suppress the effects of distortion generated in the outer sleeve 29 or the like when the hub 28 is fixed by the interference-fitting, and thus, the axial runout of the setting surface 28f in the direction of the rotational axis can be reduced. Hence, the axial runout of the recording disk 8 that is set on the setting surface 28f and rotated can be reduced.

Similarly, the hub 28 may be cut in a state in which the hub 28 is fixed to the outer sleeve 29, so that the outer peripheral surface of the fitting part 28b becomes parallel with respect to the rotational axis R. In this case, the outer peripheral surface of the fitting part 28b is cut by the cutting tool, that moves in a direction parallel with respect to the rotational axis of the outer sleeve 29 and the inner sleeve 30, and cuts the hub 28 that is held by the jig of the cutting apparatus and rotated.

Accordingly, by cutting the hub 28 to form the fitting part 28b and the setting surface 28f after the hub 28 is fixed to the outer sleeve 29, it is possible to reduced the axial runout of the recording disk 8 that is set and fixed on the fitting part 28b and the setting surface 28f and rotated.

(Cap)

The cap 12 is formed by a member having a ring shape in the top view. The cap 12 includes a hollow disk-shaped lid part 12a, a cylindrical part 12b projecting downwardly in a ring shape from an outer periphery of the lid part 12a. The cap 12 is fixed to an upper end part 29c of the outer sleeve 29.

The cylindrical part 12b of the cap 12 fits on an outer peripheral surface of the upper end part 29c of the outer sleeve 29, and is fixed by an adhesive. This adhesive may include a fluorescent material. The lid part 12a of the cap 12 covers a first gas-liquid interface 93 of the lubricant 92 formed at a part where the top flange 26b of the shaft 26 opposes the upper end part 29c of the outer sleeve 29 in the radial direction, in order to suppress scattering of the lubricant 92 within the disk drive unit 100.

The cap 12 may be made of a mild steel material, such as SUS303 which is a type of stainless steel, SUS430, or the like. The cap 12 may be formed into a shape having the ring shape in the top view, by cutting the mild steel material, for example.

(Clamper)

The clamper 36 has a hollow disk-shape in the top view, and is formed by subjecting a steel material, such as SUS303, or the like, for example, to cutting, pressing, or the like. The clamper 36 is fixed to an upper surface of the hub 28, and a lower surface of the clamper 36 makes contact with an upper surface of the recording disk 8. A plurality of recording disks 8 may be fixed on the setting part 28c of the hub 28 by interposing a spacer between two adjacent recording disks 8.

(Yoke)

The yoke 31 has a cylindrical shape, and may be made of a soft magnetic steel material, or the like, for example. The yoke 31 may be formed by subjecting the soft magnetic steel material to cutting, pressing, or the like, for example. The yoke 31 is fixed to an inner peripheral surface of the fitting part 28b, using an adhesive or the like, for example. This adhesive used to fix the yoke 31 may include a fluorescent material.

(Magnet)

The magnet 32 has a cylindrical shape, and is fixed to an inner peripheral surface of the yoke 31, using an adhesive or the like, for example. The magnet 32 may be made of a ferrite magnetic material, a rare earth magnetic material, or the like, for example, and may include a binder made of a resin such as polyamide, or the like, for example. The adhesive used to fix the magnet 33 may include a fluorescent material.

The magnet 32 is magnetized to have twelve (12) poles, for example, along a circumferential direction of an inner peripheral surface thereof, and opposes an outer peripheral surface of the salient poles provided on the stator core 40 via a gap in the radial direction.

(Stator Core)

The stator core 40 includes a ring-shaped part having a ring shape in the top view, and a plurality of salient poles extending from the ring-shaped part on the outer peripheral side along the radial direction. The stator core 40 is fixed by being press-fit or loosely fitted on an outer peripheral surface of the projecting part 4c that projects in a cylindrical shape from the bottom surface of the base 4. The stator core 40 may be formed by stacking a plurality of thin electromagnetic steel plates into a single plate member by caulking, for example. The surface of the stator core 40 is subjected to an insulator coating, such as electro-coating, powder coating, or the like, for example. The coil 42 is wound on each salient pole of the stator core 40.

The driving mechanism generates a driving magnetic flux along the salient poles by supplying to the coil 42 a three-phase driving current having an approximately sinusoidal waveform. As a result, a torque is generated by an electromagnetic effect between the driving magnetic flux that is generated and a magnetic flux of the poles of the magnet 32.

(Shaft)

The shaft 26 may be formed to an approximately cylindrical shape by subjecting a steel material, such as SUS420J2 which is a type of stainless steel, or the like, for example, to cutting. The shaft 26 is provided so that the axial direction thereof is parallel to the rotational axis R. The shaft 26 includes a fixing screw hole 26a provided along the axial direction, and the top flange 26b projecting from an upper end part of the shaft 26 in a ring shape towards the outer peripheral direction.

The shaft 26 is inserted into the shaft hole 30a of the inner sleeve 30, and a lower end side of the shaft 26 is fixedly supported on the thrust cap 27. The shaft body formed by the shaft 26 and the thrust cup 27, and the thrust cup 27 on the lower end side is fixed to the base 4, while the shaft 26 on the upper end side is fixed to the top cover 2 by the fixing screw 6 that is screwed into the fixing screw hole 26a.

(Thrust Cup)

The thrust cup 27 may be made of a steel material such as SUS430, or the like, a metal material such as brass, or the like, for example, and may be formed into a cup shape having a ring shape in the top view by cutting the steel or metal material. The thrust cup 27 may be subjected to a surface treatment such as electroless nickel plating or the like, for example, in order to form a surface treated layer thereon. The thrust cup 27 includes a support part 27a that fixedly supports the lower end part of the shaft 26, and the surrounding part 27b that surrounds the lower end part 29a of the outer sleeve 29. The thrust cup 27 is fixed to the base 4 by being press-fit, bonded, press-fit and bonded, or the like into the center hole 4d of the base 4. An adhesive used to fix the thrust cup 27 to the base 4 by the bonding or the press-fitting and bonding may include a fluorescent material.

A recess 27c, that is constricted towards the inner peripheral side in the radial direction, is provided on the outer peripheral surface at the upper end of the surrounding part 27b of the thrust cup 27. The cylindrical part 28d of the hub 28 fits into the recess 27c that is arranged to receive the cylindrical part 27b.

(Lubricant)

The lubricant 92 is provided, as a lubricant fluid, in predetermined gaps between the rotor part and the stator part. The lubricant 92 is provided between the sleeve, formed by the outer sleeve 29 and the outer sleeve 30, and each of the shaft 26 and the thrust cup 27, and is held in the respective holding gaps 91.

(Dynamic Pressure Generating Part)

A radial dynamic pressure generating mechanism and a thrust dynamic pressure generating mechanism are provided at predetermined parts between the rotor part and the stator part. The first radial dynamic pressure generating part 81 is formed at the upper side of the holding gap 91 between the outer peripheral surface of the shaft 26 and the inner peripheral surface of the inner sleeve 30, and a second radial dynamic pressure generating part 82 is formed at the lower side of the holding gap 91 between the outer peripheral surface of the shaft 26 and the inner peripheral surface of the inner sleeve 30. The first and second radial dynamic pressure generating parts 81 and 82 are provided at locations that are separated along the axial direction.

A first radial dynamic pressure generating groove 30c having a herringbone shape or a spiral shape, for example, is provided in the inner peripheral surface of the inner sleeve 30 at a part opposing the first radial dynamic pressure generating part 81. In addition, a second radial dynamic pressure generating groove 30d having a herringbone shape or a spiral shape, for example, is provided in the inner peripheral surface of the inner sleeve 30 at a part opposing the second radial dynamic pressure generating part 82. At least one of the first and second radial dynamic pressure generating grooves 30c and 30d may be provided in the outer peripheral surface of the shaft 26.

A first thrust dynamic pressure generating part 83 is provided at the gap between the upper surface of the inner sleeve 30 and the lower surface of the top flange 26b. In addition, a second thrust dynamic pressure generating part 84 is provided at the gap between the lower surface of the inner sleeve 30 and the upper surface of the support part 27a of the thrust cup 27.

A first thrust dynamic pressure generating groove 30e having a herringbone shape or a spiral shape, for example, is provided in the upper surface of the inner sleeve 30 at a part opposing the first thrust dynamic pressure generating part 83. In addition, a second thrust dynamic pressure generating groove 30f having a herringbone shape or a spiral shape, for example, is provided in the lower surface of the inner sleeve 30 at a part opposing the second thrust dynamic pressure generating part 84. The first thrust dynamic pressure generating groove 30e may be provided in the lower surface of the top flange 26b, and the second thrust dynamic pressure generating groove 30f may be provided in the upper surface of the support part 27a of the thrust cup 27.

When the rotor part, including the hub 28, the outer sleeve 29, and the inner sleeve 30, rotates with respect to the stator part, including the shaft 26 and the thrust cup 27, a dynamic pressure is generated in the lubricant 92 at each of the first radial dynamic pressure generating part 81, the second radial dynamic pressure generating part 82, the first thrust dynamic pressure generating part 83, and the second thrust dynamic pressure generating part 84. The inner sleeve 30 is supported in the axial direction and in the radial direction by the dynamic pressures generated in the lubricant 92, in a non-contact state in which the inner sleeve 30 does not make contact with the shaft 26 and the thrust cup 27, and the inner sleeve 30 rotates in this non-contact state together with the hub 28 and the outer sleeve 29.

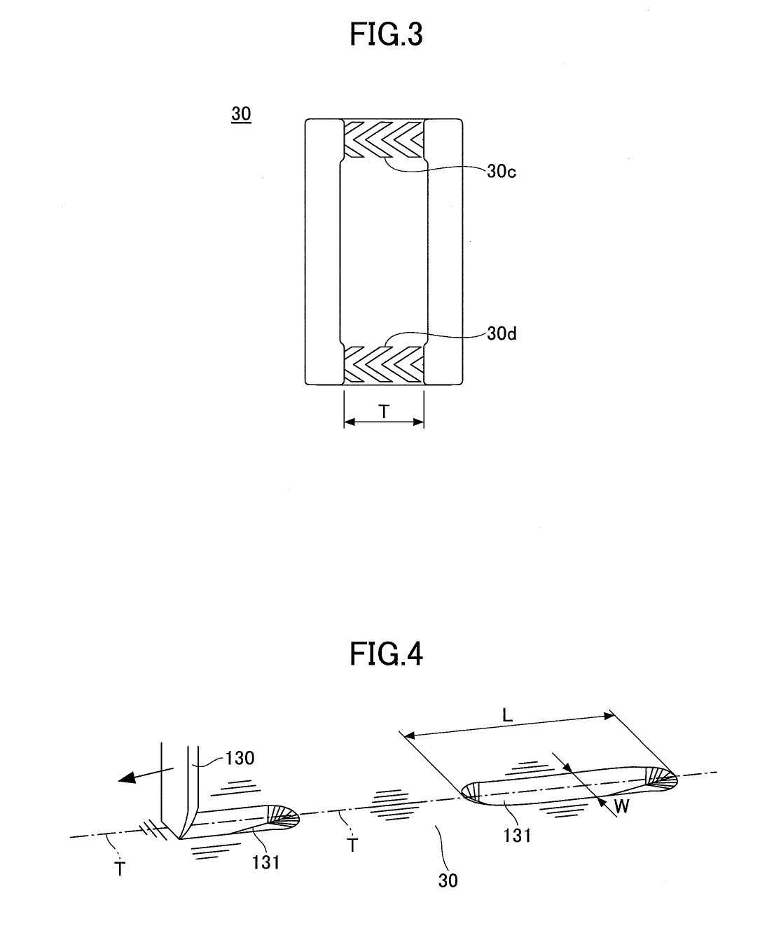

FIG. 3 is a diagram illustrating an example of the first and second radial dynamic pressure generating grooves 30c and 30d formed in the inner peripheral surface of the inner sleeve 30 in the first embodiment.

In this embodiment, the first and second radial dynamic pressure generating grooves 30c and 30d are formed in the inner peripheral surface of the inner sleeve 30 at the locations separated along the axial direction, as illustrated in FIG. 3. Each of the first and second radial dynamic pressure generating grooves 30c and 30d has the herringbone shape including inclined grooves inclined with respect to a circumferential direction T.

The first and second radial dynamic pressure generating grooves 30c and 30d may be formed by a cutting apparatus including a cutting tool whose position can be finely controlled using a piezoelectric element, for example. In the cutting apparatus, the inner sleeve 30 is rotated in a state held by a jig, and the cutting tool makes contact with the inner peripheral surface of the inner sleeve 30 and cuts while moving in the axial direction, to thereby form the at least one of the first and second radial dynamic pressure generating grooves 30c and 30d.

FIG. 4 is a diagram schematically illustrating a state in which a cutting tool 130 forms a microgroove 131 in the cutting apparatus.

Because the inner sleeve 30 is rotated in the state held by the jig, the cutting tool 130 moves in the direction of an arrow relative to the inner sleeve 30 along the circumferential direction T, as illustrated in FIG. 4. In addition, the cutting tool 130 is displaced in an up-and-down direction in FIG. 4 when an alternating field is applied to the piezoelectric element. As a result, the cutting tool 130 cuts a desired position on the inner peripheral surface of the rotating inner sleeve 30, in order to form the microgroove 131.

A width W of the microgroove 131 that is formed, along a direction perpendicular to the circumferential direction T, is in a range of 0.02 mm to 0.2 mm, for example. In addition, a length L of the microgroove 131 that is formed, along the circumferential direction T, is in a range of 0.2 mm to 2 mm, for example. Further, a depth of the microgroove 131 that is formed is in a range of 3 μm to 50 μm, for example.

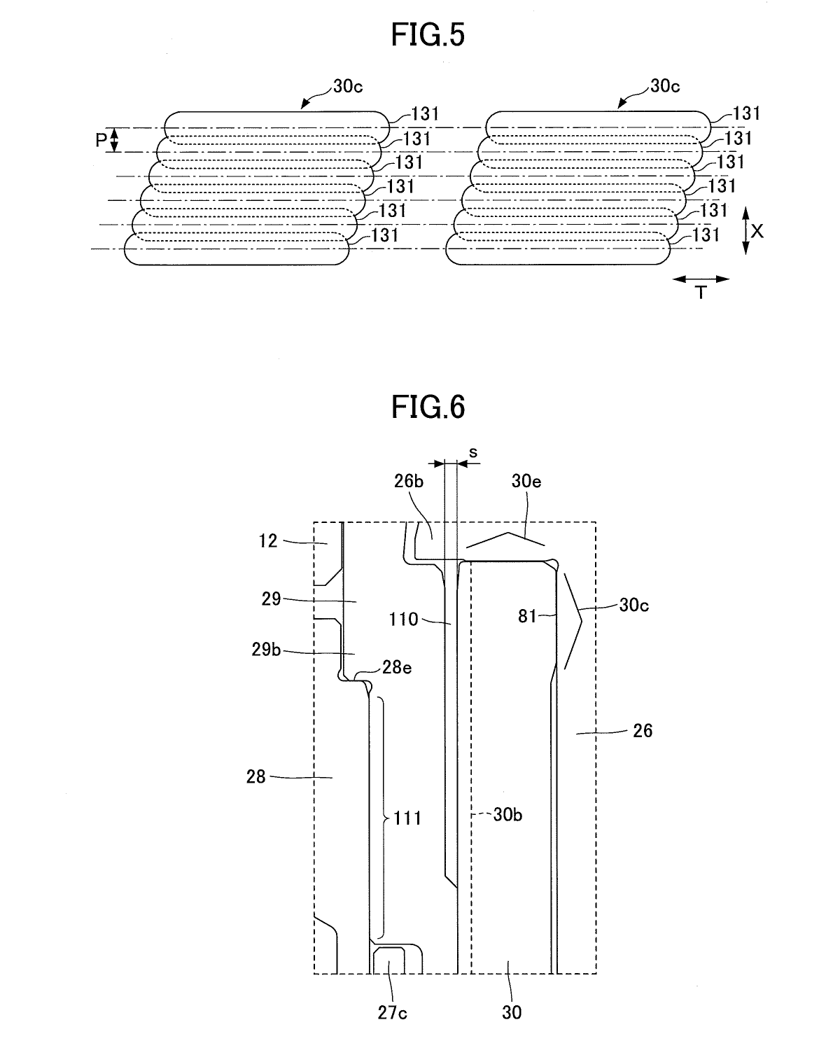

FIG. 5 is a diagram, on an enlarged scale, illustrating an example of the first radial dynamic pressure generating groove 30c in the first embodiment.

As illustrated in FIG. 5, the cutting tool 130 cuts and forms the microgrooves 131 at a predetermined position along the circumferential direction T, while moving at a predetermined pitch P along a direction X that is perpendicular to the circumferential direction T with respect to the rotating inner sleeve 30. The pitch P at which the cutting tool 130 moves is smaller than the width W of the microgrooves 131, and the microgrooves 131 are cut so as to overlap in the direction X. The first radial dynamic pressure generating groove 30c is formed by cutting the inner peripheral surface of the inner sleeve 30 by the cutting tool 130 so that the plurality of microgrooves 131 extending in the circumferential direction T overlap in the direction X. In addition, the second radial dynamic pressure generating groove 30d is formed in a manner similar to the first radial dynamic pressure generating groove 30c, by cutting the inner peripheral surface of the inner sleeve 30 by the cutting tool 130 so that the plurality of microgrooves 131 extending in the circumferential direction T overlap in the direction X.

The first radial dynamic pressure generating groove 30c, the second radial dynamic pressure generating groove 30d, the first thrust dynamic pressure generating groove 30e, and the second thrust dynamic pressure generating groove 30f may be formed by the cutting apparatus described above, or may be formed by other methods. Such other methods may include forming the dynamic pressure generating groove by pressing, form-rolling such as that used to form a ball screw groove, electro-chemical machining, or the like, for example.

(Lubricant Holding Structure)

A seal structure for suppressing a leak of the lubricant is provided in a lubricant holding structure that holds the lubricant fluid between the rotor part and the stator part. The seal structure may include a tapered space that widens towards the outer part.

The lubricant 92 is held in the holding gaps 91 between the shaft 26 and the thrust cup 27 and between the outer sleeve 29 and the inner sleeve 30. As illustrated in FIG. 2, the first gas-liquid interface 93 is formed between the top flange 26b of the shaft 26 and the upper end part 29c of the outer sleeve 29.

A tapered (or sloping) surface that increases in diameter in a downward direction in FIG. 2 along the axial direction is formed on the outer peripheral surface of the top flange 26b of the shaft 26. By forming this tapered surface on the outer peripheral surface of the top flange 26b, a first tapered space 94 is formed between the outer peripheral surface of the top flange 26b and the inner peripheral surface of the upper end part 29c of the outer sleeve 29. A gap of this first tapered space 94 decreases towards the holding gap 91, that is, in the downward direction along the axial direction.

The lubricant 92 is contained (or sealed) between the top flange 26b and the upper end part 29c of the outer sleeve 29, since in FIG. 2, a force acts on the lubricant 92 in the downward direction in which the gap of the first tapered space 94 decreases, due to capillarity. The first tapered space 94 functions as a capillary seal (hereinafter also referred to as a “tapered seal”), and seals the lubricant 92 so that the lubricant 92 is held in the holding gap 91.

The cap 12 is provided to cover the first gas-liquid interface 93, and suppresses scattering of the lubricant 92 from the first gas-liquid interface 93 to the disk accommodating space 24, by capturing the lubricant 92 that scatters from the first gas-liquid interface 93.

In addition, the lubricant 92 forms a second gas-liquid interface 95 between the lower end part 29a of the outer sleeve 29 and the surrounding part 27b of the thrust cup 27.

A tapered (or sloping) surface that increases in diameter in an upward direction in FIG. 2 along the axial direction is formed on the outer peripheral surface of the lower end part 29a of the outer sleeve 29. By forming this tapered surface on the outer peripheral surface of the lower end part 29a, a second tapered space 96 is formed between the lower end part 29a of the outer sleeve 29 and the surrounding part 27b of the thrust cup 27. A gap of this second tapered space 96 decreases towards the holding gap 91, that is, in the downward direction along the axial direction.

The lubricant 92 is contained (or sealed) between the lower end part 29a of the outer sleeve 29 and the surrounding part 27b of the thrust cup 27, since in FIG. 2, a force acts on the lubricant 92 in the downward direction in which the gap of the second tapered space 96 decreases, due to capillarity. The second tapered space 96 functions as a capillary seal (or “tapered seal”), and seals the lubricant 92 so that the lubricant 92 is held in the holding gap 91.

In addition, the cylindrical part 28d of the hub 28 covers the gap between the surrounding part 27b of the thrust cup 27 and the outer sleeve 27, and suppresses scattering of the lubricant from the second gas-liquid interface 95 to the disk accommodating space 24.

(Ring-Shaped Recess)

FIG. 6 is a diagram, on an enlarged scale, illustrating an example of a configuration of the ring-shaped recess 110 of the disk drive unit 100 in the first embodiment. As illustrated in FIG. 6, the ring-shaped recess 110 in this example is formed by a part of the inner peripheral surface of the outer sleeve 29, that is constricted towards the outer peripheral side in the radial direction. However, the ring-shaped recess 110 may be formed by a part of the outer peripheral surface of the outer sleeve 29, that is constricted towards the inner peripheral side in the radial direction. Further, the ring-shaped recess 110 may be formed by a combination of the part of the inner peripheral surface of the outer sleeve 29, that is constricted towards the outer peripheral side in the radial direction, and the part of the outer peripheral surface of the outer sleeve 29, that is constricted towards the inner peripheral side in the radial direction.

The ring-shaped recess 110 is formed between the inner peripheral surface of the outer sleeve 29 and the outer peripheral surface of the inner sleeve 30. The ring-shaped recess 110 is formed in the region that overlaps at least a part of the first radial dynamic pressure generating part 81 along the axial direction, and is formed in the ring shape to surround the rotational axis R.

A lower end of the ring-shaped recess 110 is formed to be located between a lower end of the first radial dynamic pressure generating groove 30c and a lower end of a fixing region 111 along the axial direction. The hub 28 makes contact with and is fixed to the outer peripheral surface of the outer sleeve 29 at this fixing region 111. An upper end of the ring-shaped recess 110 is formed to be located on the upper side than an upper end of the fixing region 111 along the axial direction.

By providing the ring-shaped process 110 between the outer sleeve 29 and the inner sleeve 30, it is possible to suppress deformation of the inner sleeve 30 caused by the outer sleeve 29 being fixed thereto by the interference-fitting. Accordingly, because the gap between the inner sleeve 30 and the shaft 26 can be maintained in the first radial dynamic pressure generating part 81, a variation of the dynamic pressure generated in the lubricant 92 within the first radial dynamic pressure generating part 81 can be reduced, and a stable rotation of the rotor part including the inner sleeve 30 can be maintained.

In addition, in a case in which a gap s of the ring-shaped recess 110 in the radial direction is large, it is easier to absorb the effects on the inner sleeve 30 of the hub 28 being fixed to the outer peripheral surface of the outer sleeve 29, and the rotation of the rotor part including the inner sleeve 30 can be maintained more stably. The effects on the inner sleeve 30 can be absorbed when the gap s is 5 μm, more notably absorbed when the gap s is 20 μm, and even more notably absorbed together with a manufacturing error when the gap s is 50 μm. In a case in which the gap s is small, the amount of the lubricant 92 supplied to the ring-shaped recess 110 decreases, and a time required for an operation to supply the lubricant 92 can be reduced. In a case in which the gap s is 500 μm or less, the time required for the operation to supply the lubricant 92 falls within a tolerable range.

(Method of Manufacturing Disk Drive Unit)

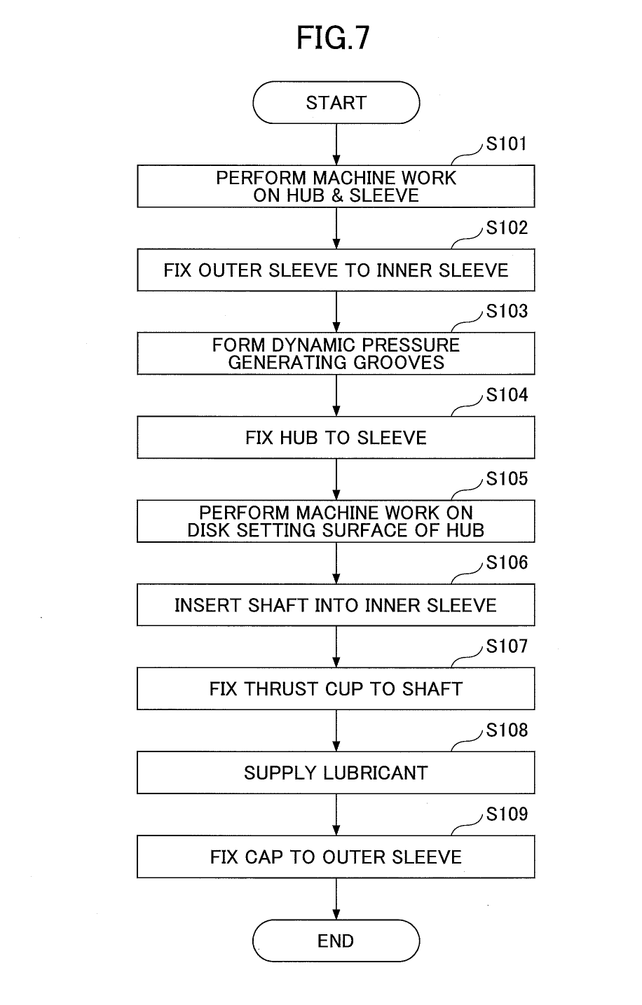

FIG. 7 is a diagram for explaining a method of manufacturing the disk drive unit 100 in the first embodiment, and more particularly, the bearing mechanism of the disk drive unit 100. In the method of manufacturing the disk drive unit 100 described hereunder in conjunction with FIG. 7, steps may be interchanged where appropriate, and one or more steps may be added where appropriate.

As illustrated in FIG. 7, in step 5101, machine work is performed on the hub 28, the outer sleeve 29, and the inner sleeve 30. More particularly, the hub 28 is pressed and cut, in order to form the cylindrical part 28d and the engaging part 28e. In addition, the outer sleeve 29 is cut, in order to form the stepped part 29b, and a recess forming the ring-shaped recess 110 between inner peripheral surface of the outer sleeve 29 and the outer peripheral surface of the inner sleeve 30. Further, the inner sleeve 30 is cut, in order to form the D-cut surface or the like on the outer peripheral surface of the inner sleeve 30. In the case in which the outer sleeve 29 and the inner sleeve 30 are integrally formed by the single sleeve member, the circulating passage that includes the hole extending in the axial direction may be provided in the sleeve member.

In step S102, the inner sleeve 30 is press-fit into the outer sleeve 29, and the outer sleeve 29 is fixed to the outer peripheral surface of the inner sleeve 30.

In step S103, the dynamic pressure generating grooves are formed in the sleeve. In this embodiment, the cutting apparatus described above forms the first radial dynamic pressure generating groove 30c and the second radial dynamic pressure generating groove 30d in the inner peripheral surface of the inner sleeve 30. The machine work, such as cutting or the like, for example, may be performed continuously so that the inner peripheral surface of the inner sleeve 30 is smoothened before forming the dynamic pressure generating grooves. Next, the cutting apparatus forms the first thrust dynamic pressure generating groove 30e and the second thrust dynamic pressure generating groove 30f in the upper and lower end surfaces of the inner sleeve 30, respectively.

Thereafter, in step S104, the hub 28 is fixed to the outer peripheral surface of the outer sleeve 29 by interference-fitting, such as press-fitting, shrink-fitting, or the like, for example.

Next, in step S105, in the state in which the hub 28 is fixed to the outer sleeve 29, the setting surface 28f of the hub 28 on which the recording disk 8 is to be set is cut to be perpendicular to the rotational axis R. As described above, the the setting surface 28f is cut by the cutting tool that moves in the direction perpendicular to the rotational axis of the hub 28, the outer sleeve 29, and the inner sleeve 30 that rotate in a state held by the jig of the cutting apparatus.

The outer peripheral surface of the fitting part 29b may be cut to be parallel to the rotational axis R, continuously with the cutting of the setting surface 28f.

The setting surface 28f and the outer peripheral surface of the fitting part 28b may be cut by a single cutting tool that moves continuously.

In step S106, the shaft 26 is inserted into the shaft hole 30a of the inner sleeve 30. Next, in step S107, the lower end part of the shaft 26 is press-fit and fixed to the thrust cup 27. In step S108, the lubricant 92 is supplied between the top flange 26b of the shaft 26 and the upper end part 29c of the outer sleeve 29. In step S109, the cap 12 is fixed on the upper end part 29c of the outer sleeve 29.

As described above, in the disk drive unit 100 according to the first embodiment, the setting surface 28f of the hub 28 is cut to be perpendicular to the rotational axis R, in the state in which the hub 28 is fixed to the outer sleeve 29. Hence, the axial runout of the setting surface 28f in the direction of the rotational axis R can be reduced, and the axial runout of the recording disk 8 that is set on the setting surface 28f and rotated can also be reduced.

In addition, by providing the ring-shaped process 110 between the outer sleeve 29 and the inner sleeve 30, it is possible to absorb the effects on the inner sleeve 30 caused by the outer sleeve 29 that fixed to the inner sleeve 30 by the interference-fitting. Accordingly, because the gap between the inner sleeve 30 and the shaft 26 can be maintained, the variation of the dynamic pressure generated in the lubricant 92 can be reduced, and the stable rotation of the rotor part including the inner sleeve 30 can be maintained.

### Second Embodiment

Next, a description will be given of a second embodiment. Illustration and description of those constituent elements of the second embodiment that are the same as those of the first embodiment described above will be omitted.

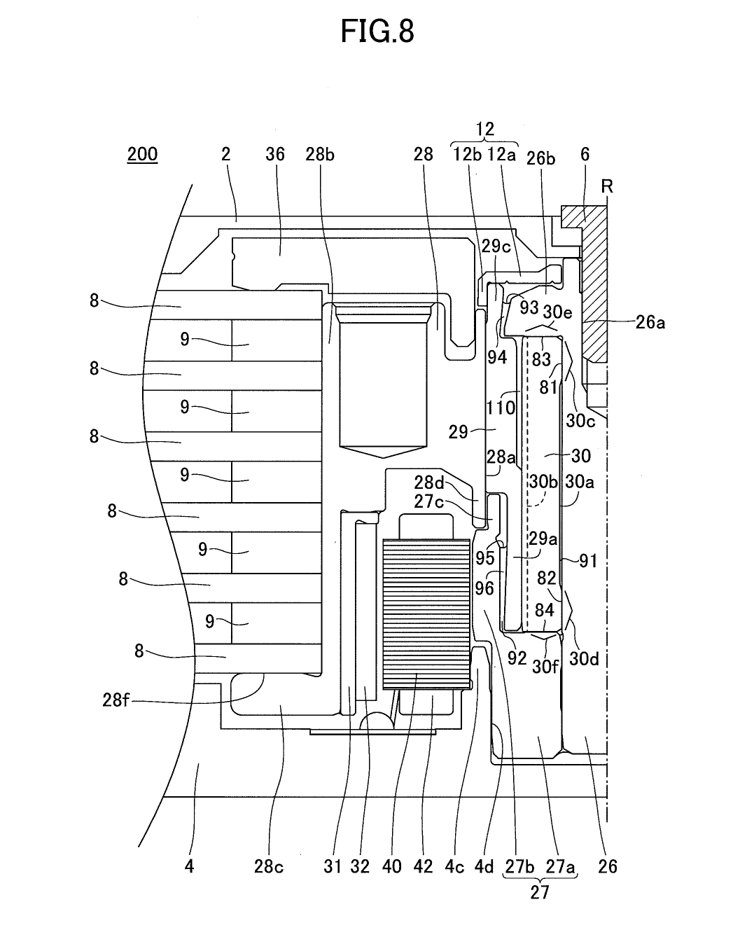

FIG. 8 is a cross sectional view illustrating an example of the bearing mechanism of a disk drive unit 200 in the second embodiment.

In the disk drive unit 200 according to the second embodiment, the setting surface 28f of the hub 28 is cut to be perpendicular to the rotational axis R, in the state in which the hub 28 is fixed to the outer sleeve 29, in a manner similar to the first embodiment described above. In addition, the ring-shaped recess 110 is formed between the outer sleeve 29 and the inner sleeve 30 in the region that overlaps at least a part of the first radial dynamic pressure generating part 81 along the axial direction, and is formed in the ring shape to surround the rotational axis R.

The disk drive unit 200 according to the second embodiment differs from the disk drive unit 100 according to the first embodiment, in that the stepped part 29b of the outer sleeve 29 and the engaging part 28e of the hub 28 are not provided in the disk drive unit 200.

The hub 28 of the disk drive unit 200 is fixed to the outer peripheral surface of the outer sleeve 29 by interference-fitting, such as press-fitting, shrink-fitting, or the like, for example. The hub 28 and the outer sleeve 29 can be positioned along the axial direction using a jig or the like at the time of assembling the disk drive unit 200.

The longer the region in which the hub 28 and the outer sleeve 29 make contact with each other along the axial direction, the more rigidly the hub 28 and the outer sleeve 29 become fixed to each other, to thereby improve the stability of the rotation of the rotor part including the hub 28 and the outer sleeve 29. Accordingly, in the disk drive unit 200 according to the second embodiment, the hub 28 and the outer sleeve 29 are rigidly fixed to each other, and the rotor part including the hub 28 and the outer sleeve 29 can rotate with improved stability.

As described above, in the disk drive unit 200 according to the second embodiment, the axial runout of the setting surface 28f of the hub 28 in the direction of the rotational axis R can be reduced, and the axial runout of the recording disk 8 that is set on the setting surface 28f and rotated can also be reduced. In addition, the gap between the shaft 26 and the inner sleeve 30 can be maintained by the provision of the ring-shaped recess 110, and the stable rotation of the rotor part can be maintained by the dynamic pressure generated in the lubricant 92. Further, the hub 28 is rigidly fixed to the outer sleeve 29, and for this reason, the rotor part including the hub 28 and the outer sleeve 29 can rotate with improved stability.

### Third Embodiment

Next, a description will be given of a third embodiment. Illustration and description of those constituent elements of the third embodiment that are the same as those of the first or second embodiment described above will be omitted.

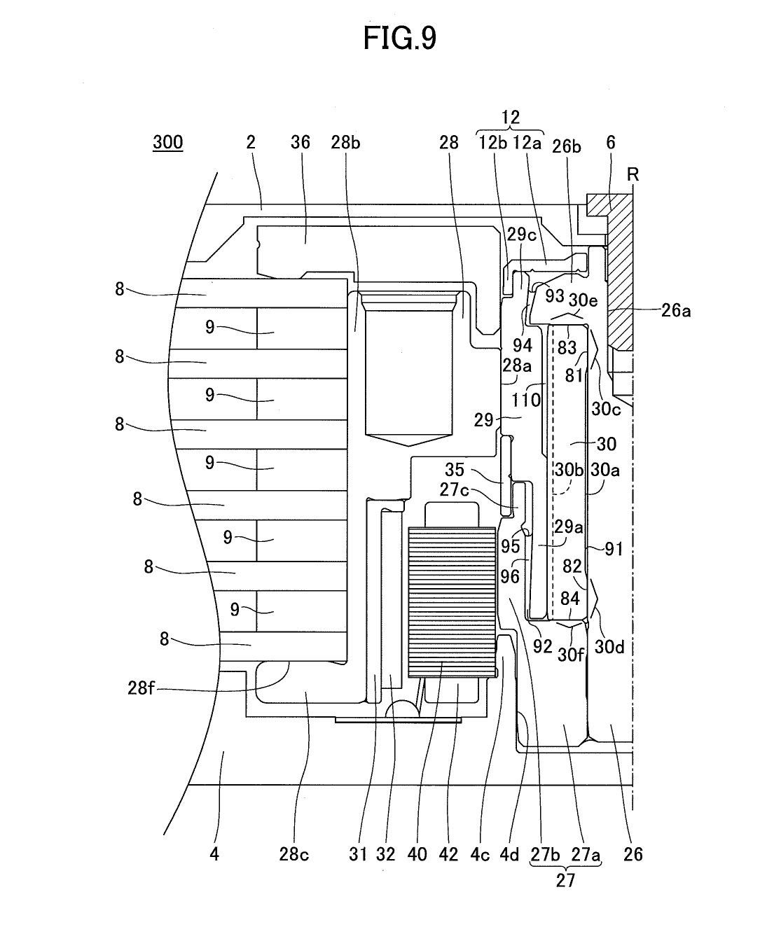

FIG. 9 is a cross sectional view illustrating an example of the bearing mechanism of a disk drive unit 300 in the third embodiment.

In the disk drive unit 300 according to the third embodiment, the setting surface 28f of the hub 28 is cut to be perpendicular to the rotational axis R, in the state in which the hub 28 is fixed to the outer sleeve 29, in a manner similar to each of the first and second embodiments described above. In addition, the ring-shaped recess 110 is formed between the outer sleeve 29 and the inner sleeve 30 in the region that overlaps at least a part of the first radial dynamic pressure generating part 81 along the axial direction, and is formed in the ring shape to surround the rotational axis R.

Similarly as in the case of the disk drive unit 200 according to the second embodiment, the disk drive unit 300 according to the third embodiment differs from the disk drive unit 100 according to the first embodiment, in that the stepped part 29b of the outer sleeve 29 and the engaging part 28e of the hub 28 are not provided in the disk drive unit 300. In addition, the disk drive unit 300 differs from each of the disk drive units 100 and 200 in that a cylindrical member 35 of the disk drive unit 300, that covers the gap between the outer sleeve 29 and the surrounding part 27b of the thrust cup 27, is provided as a separate member from the outer sleeve 29.

The cylindrical member 35 may be made of a steel material such as SUS303, SUS430, or the like, a metal material such as brass, or the like, for example, and may be formed into a cylindrical shape having a ring shape in the top view by cutting the steel or metal material.

The cylindrical member 35 is fixedly provided on the outer peripheral surface of the outer sleeve 29 by press-fitting, bonding, or the like, for example, before the hub 28 is fixed to the outer sleeve 29. The cylindrical member 35 covers the gap between the outer sleeve 29 and the surrounding part 27b of the thrust cup 27, so as to fit into the recess 27c provided on the upper end of the surrounding part 27b of the thrust cup 27, and thus, the cylindrical member 35 can suppress scattering of the lubricant 92 from the second gas-liquid interface 95 to the disk accommodating space 24. An adhesive may be used to fix the cylindrical member 35 to the outer peripheral surface of the outer sleeve 29, and this adhesive may include a fluorescent material.

As described above, in the disk drive unit 300 according to the third embodiment, the axial runout of the setting surface 28f of the hub 28 in the direction of the rotational axis R can be reduced, and the axial runout of the recording disk 8 that is set on the setting surface 28f and rotated can also be reduced. In addition, the gap between the shaft 26 and the inner sleeve 30 can be maintained by the provision of the ring-shaped recess 110, and the stable rotation of the rotor part can be maintained by the dynamic pressure generated in the lubricant 92. Further, the cylindrical member 35 can suppress the scattering of the lubricant 92 from the second gas-liquid interface 95 to the disk accommodating space 24.

According to each of the embodiments, it is possible to provide a disk drive unit and a method of manufacturing the same, which can reduce the axial runout of the rotating recording disk.

Although the embodiments are numbered with, for example, “first,” “second,” or “third,” the ordinal numbers do not imply priorities of the embodiments.

Although the embodiments of the present invention have been described in detail, it should be understood that the various changes, substitutions, and alterations could be made hereto without departing from the spirit and scope of the invention.

What is claimed is:

1. A method of manufacturing a disk drive unit having a stator part that includes a base and a shaft member extending in an axial direction, and a rotor part that is rotatably supported by the stator part and includes a sleeve accommodating at least a part of the shaft member, and a hub fixed to an outer peripheral surface of the sleeve and including a setting surface on which a recording disk is set, the method comprising:
fixing the hub to the outer peripheral surface of the sleeve;
cutting the setting surface by a cutting tool that moves in a direction perpendicular to a rotational axis of the rotor part while rotating the rotor part, in a state in which the hub is fixed to the outer peripheral surface of the sleeve; and
accommodating the shaft member in the sleeve after the cutting.

2. The method of manufacturing the disk drive unit as claimed in claim 1, wherein the fixing fixes the hub to the sleeve by interference-fitting.

3. The method of manufacturing the disk drive unit as claimed in claim 1, further comprising:
forming a stepped part on the outer peripheral surface of the sleeve; and
forming an engaging part that is to engage the stepped part on an inner peripheral surface of the hub,
wherein the fixing includes engaging the engaging part to the stepped part.

4. The method of manufacturing the disk drive unit as claimed in claim 1,
wherein the stator part includes a surrounding member that has an outer peripheral surface with a recess constricted in a radial direction perpendicular to the axial direction, and surrounds the sleeve,
wherein the rotor part includes a cylindrical part that covers a gap between the sleeve and the surrounding member in the axial direction, and has at least a part thereof entering the recess in the radial direction, and
wherein the method further comprises:
before the fixing, forming the cylindrical part integrally on the hub, or fixing the cylindrical part on the sleeve.

5. The method of manufacturing the disk drive unit as claimed in claim 1,
wherein the sleeve includes an inner sleeve surrounding the shaft member, and an outer sleeve fixed to an outer peripheral surface of the inner sleeve,
wherein the disk drive unit further has a first radial dynamic pressure generating groove provided on an outer peripheral surface of the shaft member or an inner peripheral surface of the inner sleeve, and a second radial dynamic pressure generating groove provided on the outer peripheral surface of the shaft member or the inner peripheral surface of the inner sleeve and separated from the first radial dynamic pressure generating groove towards the base, and
wherein the method further comprises:
before the fixing, forming a ring-shaped recess that is constricted in the radial direction and surrounds the rotational axis, on at least one of the outer peripheral surface of the inner sleeve and an inner peripheral surface of the outer sleeve in a region that overlaps at least a part of the first radial dynamic pressure generating groove along the axial direction,
wherein the fixing includes overlapping at least a part of a fixing region in which the hub makes contact with and is fixed to the sleeve, and the ring-shaped recess, along the axial direction.

6. The method of manufacturing the disk drive unit as claimed in claim 5, wherein the forming the ring-shaped recess includes forming one end part of the ring-shaped recess on the base side between the first radial dynamic pressure generating groove and the second radial dynamic pressure generating groove, and forming another end of the ring-shaped recess, opposite to the one end, on an opposite side of the base from the fixing region.

7. The method of manufacturing the disk drive unit as claimed in claim 5, wherein the forming the ring-shaped recess includes forming the ring-shaped recess to form a gap in a range of 5 μm to 500 μm in the radial direction perpendicular to the axial direction.

8. The method of manufacturing the disk drive unit as claimed in claim 5,
wherein at least one of the first radial dynamic pressure generating groove and the second radial dynamic pressure generating groove includes an inclined groove extending in an inclined direction with respect to a circumferential direction, and
wherein the method further comprises:
before the fixing, forming the inclined groove by a plurality of microgrooves extending in the circumferential direction.

9. A method of manufacturing a disk drive unit having a stator part that includes a base and a shaft member extending in an axial direction, and a rotor part that is rotatably supported by the stator part and includes a sleeve accommodating at least a part of the shaft member, and a hub fixed to an outer peripheral surface of the sleeve and including a setting surface on which a recording disk is set, the method comprising:
fixing the hub to the outer peripheral surface of the sleeve; and
cutting the setting surface by a cutting tool that moves in a direction perpendicular to a rotational axis of the rotor part while rotating the rotor part, in a state in which the hub is fixed to the outer peripheral surface of the sleeve.

10. The method of manufacturing the disk drive unit as claimed in claim 9, wherein the fixing fixes the hub to the sleeve by interference-fitting.

11. The method of manufacturing the disk drive unit as claimed in claim 9, further comprising:
forming a stepped part on the outer peripheral surface of the sleeve; and
forming an engaging part that is to engage the stepped part on an inner peripheral surface of the hub,
wherein the fixing includes engaging the engaging part to the stepped part.

12. The method of manufacturing the disk drive unit as claimed in claim 9,
wherein the stator part includes a surrounding member that has an outer peripheral surface with a recess constricted in a radial direction perpendicular to the axial direction, and surrounds the sleeve,
wherein the rotor part includes a cylindrical part that covers a gap between the sleeve and the surrounding member in the axial direction, and has at least a part thereof entering the recess in the radial direction, and
wherein the method further comprises:
before the fixing, forming the cylindrical part integrally on the hub, or fixing the cylindrical part on the sleeve.

13. The method of manufacturing the disk drive unit as claimed in claim 9,
wherein the sleeve includes an inner sleeve surrounding the shaft member, and an outer sleeve fixed to an outer peripheral surface of the inner sleeve,
wherein the-disk drive unit further has a first radial dynamic pressure generating groove provided on an outer peripheral surface of the shaft member or an inner peripheral surface of the inner sleeve, and a second radial dynamic pressure generating groove provided on the outer peripheral surface of the shaft member or the inner peripheral surface of the inner sleeve and separated from the first radial dynamic pressure generating groove towards the base, and
wherein the method further comprises:
before the fixing, forming a ring-shaped recess that is constricted in the radial direction and surrounds the rotational axis, on at least one of the outer peripheral surface of the inner sleeve and an inner peripheral surface of the outer sleeve in a region that overlaps at least a part of the first radial dynamic pressure generating groove along the axial direction,
wherein the fixing includes overlapping at least a part of a fixing region in which the hub makes contact with and is fixed to the sleeve, and the ring-shaped recess, along the axial direction.

14. The method of manufacturing the disk drive unit as claimed in claim 13, wherein the forming the ring-shaped recess includes forming one end part of the ring-shaped recess on the base side between the first radial dynamic pressure generating groove and the second radial dynamic pressure generating groove, and forming another end of the ring-shaped recess, opposite to the one end, on an opposite side of the base from the fixing region.

15. The method of manufacturing the disk drive unit as claimed in claim 13, wherein the forming the ring-shaped recess includes forming the ring-shaped recess to form a gap in a range of 5 μm to 500 μm in the radial direction perpendicular to the axial direction.

16. The method of manufacturing the disk drive unit as claimed in claim 13,
wherein at least one of the first radial dynamic pressure generating groove and the second radial dynamic pressure generating groove includes an inclined groove extending in an inclined direction with respect to a circumferential direction, and
wherein the method further comprises:
before the fixing, forming the inclined groove by a plurality of microgrooves extending in the circumferential direction.

17. A method of manufacturing a disk drive unit having a stator part that includes a base and a shaft member extending in an axial direction, and a rotor part that is rotatably supported by the stator part and includes a sleeve accommodating at least a part of the shaft member, and a hub fixed to an outer peripheral surface of the sleeve and including a setting surface on which a recording disk is set, the method comprising:
forming a stepped part on the outer peripheral surface of the sleeve;
forming an engaging part that is to engage the stepped part on an inner peripheral surface of the hub;
fixing the hub to the outer peripheral surface of the sleeve by engaging the engaging part to the stepped part; and
cutting the setting surface by a cutting tool that moves in a direction perpendicular to a rotational axis of the rotor part while rotating the rotor part, in a state in which the hub is fixed to the outer peripheral surface of the sleeve.

18. The method of manufacturing the disk drive unit as claimed in claim 17,
wherein the stator part includes a surrounding member that has an outer peripheral surface with a recess constricted in a radial direction perpendicular to the axial direction, and surrounds the sleeve,
wherein the rotor part includes a cylindrical part that covers a gap between the sleeve and the surrounding member in the axial direction, and has at least a part thereof entering the recess in the radial direction, and
wherein the method further comprises:
before the fixing, forming the cylindrical part integrally on the hub, or fixing the cylindrical part on the sleeve.

19. The method of manufacturing the disk drive unit as claimed in claim 17,
wherein the sleeve includes an inner sleeve surrounding the shaft member, and an outer sleeve fixed to an outer peripheral surface of the inner sleeve,
wherein the disk drive unit further has a first radial dynamic pressure generating groove provided on an outer peripheral surface of the shaft member or an inner peripheral surface of the inner sleeve, and a second radial dynamic pressure generating groove provided on the outer peripheral surface of the shaft member or the inner peripheral surface of the inner sleeve and separated from the first radial dynamic pressure generating groove towards the base, and
wherein the method further comprises:
before the fixing, forming a ring-shaped recess that is constricted in the radial direction and surrounds the rotational axis, on at least one of the outer peripheral surface of the inner sleeve and an inner peripheral surface of the outer sleeve in a region that overlaps at least a part of the first radial dynamic pressure generating groove along the axial direction,
wherein the fixing includes overlapping at least a part of a fixing region in which the hub makes contact with and is fixed to the sleeve, and the ring-shaped recess, along the axial direction.

20. The method of manufacturing the disk drive unit as claimed in claim 19, wherein the forming the ring-shaped recess includes forming one end part of the ring-shaped recess on the base side between the first radial dynamic pressure generating groove and the second radial dynamic pressure generating groove, and forming another end of the ring-shaped recess, opposite to the one end, on an opposite side of the base from the fixing region.
